(19) United States
(12) Patent Application Publication
(10) Pub. No.: US 2007/0296313 A1
(43) Pub. Date: Dec. 27, 2007

(54) Self-generating system for an exercise apparatus

(76) Inventor: Leao Wang, Taiping (TW)

Correspondence Address: KUO-HSIUNG CHIU, 13F., NO.23, JIUN-HO STREET, PEITUN DISTRICT, TAICHUNG, 406, omitted

(21) Appl. No.: 11/474,528

(22) Filed: Jun. 27, 2006

(51) Int. Cl. H02K 7/18; B62J 6/12; H02K 17/00

(52) U.S. Cl. 310/67 A; 310/166; 290/1 A

(57) ABSTRACT

A self-generating system for an exercise apparatus including a flywheel having a flange with a plurality of permanent magnets fixed on the circumference of thereof. At least one set of induction coils opposing to the permanent magnets is supported on the a mounting foot such that the induction coils surround the permanent magnets with a proper gap between them. Accordingly, an induction takes place between the permanent magnets and the induction coils after the flywheel is brought into rotation. Meanwhile, the inducted electric energy may be transmitted by a power cord to necessary electronic devices (like a motor and an electric console) on the exercise apparatus, thereby achieving the self-generating effect.

### BACKGROUND OF THE INVENTION

1. Fields of the Invention

The invention relates to a self-generating system for an exercise apparatus, and more particularly, to a self-generating system that includes a flywheel. Meanwhile, a plurality of permanent magnets and induction coils are fitted to proper position. Accordingly, an electric induction takes place when a flywheel is forced to rotation. Thus, the induced electric energy can be provided for the operation of the exercise apparatus.

2. Description of the Related Art

It is well-known that the inertia turning effort caused by applying a force to a flywheel can serve as resistance for taking exercise on an exercise apparatus (like fitness bike 10, rowing exerciser, elliptical cross trainer, treadmill, chest expander, weight-lifting set, etc.). U.S. Pat. No. 6,626,804 discloses a structure having a magnetic control element on the circumference of the flywheel. The position of the magnetic control element can be adjusted by a motor for controlling the amount of the magnetic resistance. In this way, a more practical exercise effect can be achieved.

However, the operation of the motor requires electric energy so as to achieve the desired control effect. Besides, the electric console on the exercise apparatus also needs the electric energy to achieve the expected control effect. Thus, the installation position of the conventional exercise apparatus is dependent on the position of the mains socket or requires an extension cord for connecting power so as to ensure a normal operation of the exercise apparatus due to a continual power supply. In case of any power failure, the exercise apparatus is useless, thereby causing the operator much inconvenience.

### SUMMARY OF THE INVENTION

It is a primary object to eliminate the above-mentioned drawbacks and to provide a self-generating system for an exercise apparatus that includes a flywheel. Meanwhile, a plurality of permanent magnets and induction coils are fitted to proper position. Accordingly, an electric induction takes place when a flywheel is forced to rotation. Thus, the induced electric energy can be provided for the operation of the exercise apparatus. In this way, the convenience in use is considerably increased due to the self-generating function of the system in accordance with the invention.

In order to achieve the above-mentioned object, a self-generating system for an exercise apparatus includes a flywheel having a flange with a plurality of permanent magnets fixed on the circumference of thereof. At least one set of induction coils opposing to the permanent magnets is supported on the a mounting foot such that the induction coils surround the permanent magnets with a proper gap between them. Accordingly, an induction takes place between the permanent magnets and the induction coils after the flywheel is brought into rotation. Meanwhile, the inducted electric energy may be transmitted by a power cord to necessary electronic devices on the exercise apparatus, thereby achieving the self-generating effect.

### BRIEF DESCRIPTION OF THE DRAWINGS

The accomplishment of this and other objects of the invention will become apparent from the following description and its accompanying drawings of which:

FIG. 1 is a schematic drawing of a preferred embodiment of the invention applied to a magnetic control fitness bike;

FIG. 2 is a rear view of the fitness bike 10 according to FIG. 1.

FIG. 3 is a schematic drawing of the preferred embodiment of the invention applied to another exercise apparatus;

FIG. 4 is a schematic drawing of another preferred embodiment of the invention;

FIG. 5 is a schematic drawing of a further preferred embodiment of the invention; and

FIG. 6 is a schematic drawing of still another preferred embodiment of the invention.

### DETAILED DESCRIPTION OF THE PREFERRED EMBODIMENT

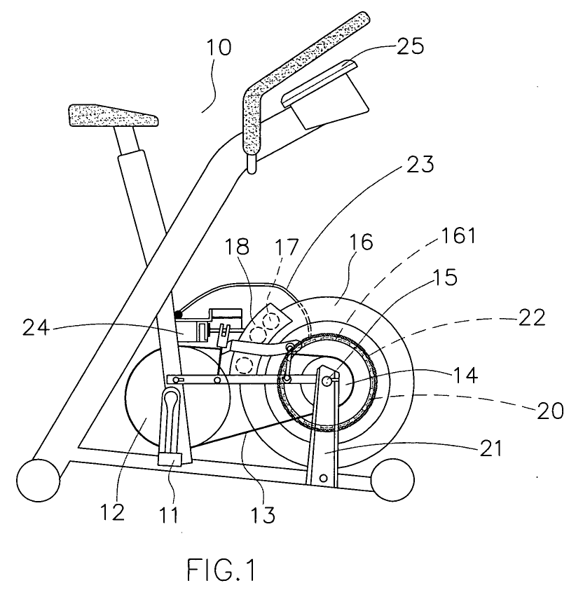

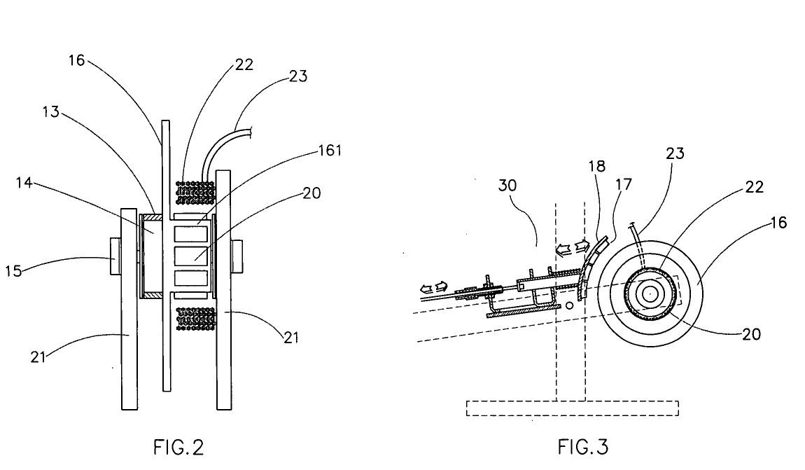

First of all, referring to FIGS. 1 and 2, a preferred embodiment of the invention in cooperation with a fitness bike 10 is shown. The use and transmission of the fitness bike 10 is done in such way that a treadle 11 is worked by continual action of the foot to impart motion to a driving sprocket 12 that drives a driven sprocket 14 via a chain 13. The driven sprocket 14 is mounted on one end of an axle 15 while a unidirectionally rotatable flywheel 16 is coaxially fitted on the other end of the axle 15. In this way, the flywheel 16 is rotatable with the driven sprocket 14 since they are mounted on the same axle 15. A magnetoresistive element 18 is fitted to one side of the flywheel 16. The magnetoresistive element 18 includes a magnet set 17. A cutting resistance is created by adjusting the gap between the magnetoresistive element 18 and the flywheel 16. The flywheel 16 includes a flange 161 with a plurality of permanent magnets 20 fixed on the circumference of the flange 161. At least one set of induction coils 22 opposing to the permanent magnets 20 is supported on the a mounting foot 21 such that the induction coils 22 surround the permanent magnets 20 with a proper gap between them. After the flywheel 16 is brought into rotation, an induction takes place between the permanent magnets 20 and the induction coils 22. The inducted electric energy can be transmitted by a power cord 23 to a motor 24 and an electric console 25 on the fitness bike 10. In this way, a self-generating system is created.

The motor 24 is employed to adjust the position of the magnetoresistive element 18 while the electric console 25 serves to control the power of the motor 24 and to set the exercise program. However, this belongs to the prior art so that no further descriptions thereto are given hereinafter.

As shown in FIG. 3, a preferred embodiment in accordance with the invention is applied to another type exercise apparatus 30. It is apparent from FIG. 3 that the control configuration and position of the flywheel 16 and the magnetoresistive element 18 is a little different from that of the previous embodiment. Therefore, the flywheel 16, the permanent magnets 20 and the induction coils 22 require only corresponding change for a smooth operation without any problems. Moreover, it is not necessary to take the transmission process of the flywheel 16 into account. Accordingly, the configuration of this embodiment meets the requirement of the convenient use.

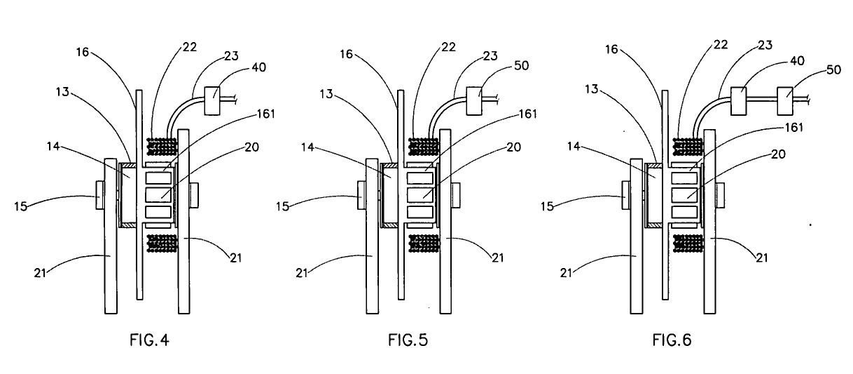

In order to achieve an effective accumulation of the electric energy and a practical conversion of the alternating current into the direct current, a battery 40 and a rectifier can be fitted to the circuit of the invention, respectively (see FIGS. 4 and 5).

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A self-generating system for an exercise apparatus comprising a flywheel having a flange with a plurality of permanent magnets fixed on the circumference of thereof, at least one set of induction coils opposing to the permanent magnets being supported on the a mounting foot such that the induction coils surround the permanent magnets with a proper gap between them,
whereby an induction takes place between the permanent magnets and the induction coils after the flywheel is brought into rotation; meanwhile, the inducted electric energy may be transmitted by a power cord to necessary electronic devices on the exercise apparatus, thereby achieving the self-generating effect.

2. The self-generating system for an exercise apparatus of claim 1 wherein the circuit is provided with a battery and a rectifier to achieve an effective accumulation of the electric energy and a practical conversion of the electric current.
